(19) United States
(12) Patent Application Publication
(10) Pub. No.: US 2004/0044900 A1
(43) Pub. Date: Mar. 4, 2004

(54) Copy protection of DVD related web content

(76) Inventors: Bei Wang, Shanghai (CN); Declan Patrick Kelly, Eindhoven (NL); Yang Peng, Shanghai (CN); Dahua He, Shanghai (CN)

Correspondence Address: Philips Electronics North America Corp., 580 White Plains Road, Tarrytown, NY, 10591-5190, US

(21) Appl. No.: 10/232,108

(22) Filed: Aug. 29, 2002

(51) Int. Cl. G06F 12/14

(52) U.S. Cl. 713/193

(57) ABSTRACT

A method, system, and computer code for running a DVD disc having a link to web content of a web site, wherein the web content is directly related the content on the DVD disc. The system generates a decryption key to decrypt the web content received from the web site by: requesting the web content from the web site, receiving from the web site a disc address set pointing to a data block on the DVD disc, acquiring knowledge of the extent of the data block, reading the data block, and mapping the data block to a decryption key. The system receives the web content and uses the decryption key to decrypt the web content.

### BACKGROUND OF THE INVENTION

The present invention relates to a method, system, and computer code for running a DVD disc having a link to web content of a web site, wherein the web content is directly related the content on the DVD disc, and wherein the system generates a decryption key to decrypt the web content received from the web site.

2. Related Art

WebDVD is a technology in which a Digital Versatile Disc or Digital Video Disc (DVD) disc is linked to web content of a web site, wherein the web content is directly related the content on the DVD disc. The content on the DVD disc may include video and audio content. WebDVD combines Digital Versatile Disc or Digital Video Disc (DVD) with Internet technology, thus providing fast access to high-quality video and audio data offered by DVD along with advantages offered by Internet technology (e.g., interactivity, dynamic updates, etc.). For example, WebDVD enables local DVD to be enhanced with HTML web pages.

It is desired that web content from a web site, where such web content relates to a DVD disc, be accessible to a user of a WebDVD system linked to the web site only when the DVD disc is running on a DVD device of the WebDVD system. Accordingly, there is a need for said access to be available only to said user.

### SUMMARY OF THE INVENTION

In first embodiments, the present invention provides a decryption method for decrypting web content associated with a DVD disc, comprising the steps of:

running, by a WebDVD system, the DVD disc on a DVD device comprised by the WebDVD system, wherein the DVD device is linked by a communication link to a web site that is targeted by the DVD disc, and wherein the WebDVD system may have access to the web content only when the DVD disc in running on the DVD device;

requesting, by the WebDVD system, the web content from the web site;

receiving, by the WebDVD system from the web site, a disc address set on the DVD disc, wherein the disc address set points to a data block on the DVD disc;

acquiring knowledge, by the WebDVD system, of the extent of the data block, wherein the data block is determined by the disc address set and the extent;

attempting by the WebDVD system to read the data block, and if a new disc address set requesting feature is operative on the WebDVD system and if said attempting is not successful then: directing the web site to send a new disc address set to replace the previously received disc address set for pointing to a new data block on the DVD disc, followed by a maximum of N repetitions of said receiving, acquiring, and attempting steps until said attempting is successful, wherein N is at least 1; and

mapping the data block to a decryption key by a defined function if said attempting is successful.

In second embodiments, the present invention provides a method for transmitting, by a web site to a WebDVD system, information that may be used by the WebDVD system to generate a decryption key, comprising the steps of:

receiving, by the web site, a present request from the WebDVD system for web content associated with a DVD disc that is running on a DVD device comprised by the WebDVD system, wherein the DVD device is linked by a communication link to the web site, wherein the web site is targeted by the DVD disc, and wherein the WebDVD system may have access to the web content only when the DVD disc is running on the DVD device;

determining, by the web site, a disc address set on the DVD disc, wherein the disc address set points to a data block on the DVD disc, wherein the data block is adapted to be mapped to the decryption key by a defined function, and wherein the decryption key is adapted to be used by the WebDVD system to decrypt the web content; and

sending, by the web site, the disc address set to the WebDVD system.

In third embodiments, the present invention provides a network, comprising a WebDVD system, wherein the WebDVD system is adapted to:

request, from a web site targeted by a DVD disc, web content associated with the DVD disc, wherein the DVD disc is running on a DVD device comprised by the WebDVD system, wherein the DVD device is linked by a communication link to the web site, and wherein the WebDVD system may have access to the web content only when the DVD disc is running on the DVD device;

receive from the web site a disc address set that points to a data block of the DVD disc;

acquire knowledge of the extent of the data block, wherein the data block is determined by the disc address set and the extent;

attempt to read the data block, and if a new disc address set requesting feature is operative on the WebDVD system and if said attempt to read the data block is not successful then: direct the web site to send a new disc address set to replace the previously received disc address set to point to a new data block on the DVD disc, and repeat a maximum of N times said receive, acquire, and attempt until said attempt is successful, wherein N is at least 1; and

map the data block to a decryption key by a defined function if said attempt is successful, wherein the decryption key may be used by the WebDVD system to decrypt the web content.

In fourth embodiments, the present invention provides a network, comprising a web site, wherein the web site is adapted to:

receive a present request from a WebDVD system for web content associated with a DVD disc that is running on a DVD device comprised by the WebDVD system, wherein the DVD device is linked by a communication link to the web site, wherein the web site is targeted by the DVD disc, and wherein the WebDVD system may have access to the web content only when the DVD disc is running on the DVD device;

determine a disc address set on the DVD disc, wherein the disc address set points to a data block on the DVD disc, wherein the data block is adapted to be mapped to a decryption key by a defined function, and wherein the decryption key is adapted to be used by the WebDVD system to decrypt the web content; and

send the disc address set to the WebDVD system.

In fifth embodiments, the present invention provides a computer program product, comprising a computer usable medium having a computer readable program code embodied therein for decrypting web content associated with a DVD disc, said computer code embedded within a readable storage device of a WebDVD system, said computer code comprising an algorithm adapted to:

request, from a web site targeted by the DVD disc, web content associated with the DVD disc, wherein the DVD disc is running on a DVD device comprised by the WebDVD system, wherein the DVD device is linked by a communication link to the web site, and wherein the WebDVD system may have access to the web content only when the DVD disc is running on the DVD device;

receive from the web site a disc address set that points to a data block of the DVD disc;

acquire knowledge of the extent of the data block, wherein the data block is determined by the disc address set and the extent;

attempt to read the data block, and if a new disc address set requesting feature is operative on the WebDVD system and if said attempt to read the data block is not successful then: direct the web site to send a new disc address set to replace the previously received disc address set to point to a new data block on the DVD disc, and repeat a maximum of N times said receive, acquire, and attempt until said attempt is successful, wherein N is at least 1; and

map the data block to a decryption key by a defined function if said attempt is successful, wherein the decryption key may be used by the algorithm to decrypt the web content.

In sixth embodiments, the present invention provides a computer program product, comprising a computer usable medium having a computer readable program code embodied therein for transmitting, by a web site to a WebDVD system, information that may be used by the WebDVD system to generate a decryption key, said computer code embedded within a readable storage device of the web site, said computer code comprising an algorithm adapted to:

receive a present request from the WebDVD system for web content associated with a DVD disc that is running on a DVD device comprised by the WebDVD system, wherein the DVD device is linked by a communication link to the web site, wherein the web site is targeted by the DVD disc, and wherein the WebDVD system may have access to the web content only when the DVD disc is running on the DVD device;

determine a disc address set on the DVD disc, wherein the disc address set points to a data block on the DVD disc, wherein the data block is adapted to be mapped to a decryption key by a defined function, and wherein the decryption key is adapted to be used by the WebDVD system to decrypt the web content; and

send the disc address set to the WebDVD system.

The present invention enables web content from a web site, where such web content relates to a DVD disc, to be accessible to a user of a WebDVD system linked to the web site only when the DVD disc is running on a DVD device of the WebDVD system.

### BRIEF DESCRIPTION OF THE DRAWINGS

FIG. 1 depicts a WebDVD system linked to a web site by a communication link such that the WebDVD system includes a DVD device, in accordance with embodiments of the present invention.

FIG. 2 depicts the DVD device of FIG. 1 on which a DVD disc is placed, in accordance with embodiments of the present invention.

FIG. 3 depicts the DVD disc of FIG. 2, in accordance with embodiments of the present invention.

FIG. 4 depicts the DVD disc of FIG. 3 showing sectors, in accordance with embodiments of the present invention.

FIG. 5 depicts the DVD disc of FIG. 4 showing a logical block, in accordance with embodiments of the present invention.

FIG. 6A depicts a direct pointer to a data block of a disc, in accordance with embodiments of the present invention.

FIG. 6B depicts a first-level indirect pointer to a data block of a disc, in accordance with embodiments of the present invention.

FIG. 6C depicts a second-level indirect pointer to a data block of a disc, in accordance with embodiments of the present invention.

FIG. 7 is a flow chart depicting decryption of web content associated with a DVD disc through mapping a data block to a decryption key, in accordance with embodiments of the present invention.

FIGS. 8A-8D depict embodiments of the mapping of FIG. 7, in accordance with embodiments of the present invention.

FIG. 9 is a flow chart that depicts sending a DVD disc address set from a web site to a WebDVD system for subsequent generation of the decryption key of FIG. 7, in accordance with embodiments of the present invention.

FIG. 10 is a table showing various methods for determining the DVD disc address set in FIG. 9, in accordance with embodiments of the present invention.

### DETAILED DESCRIPTION OF THE INVENTION

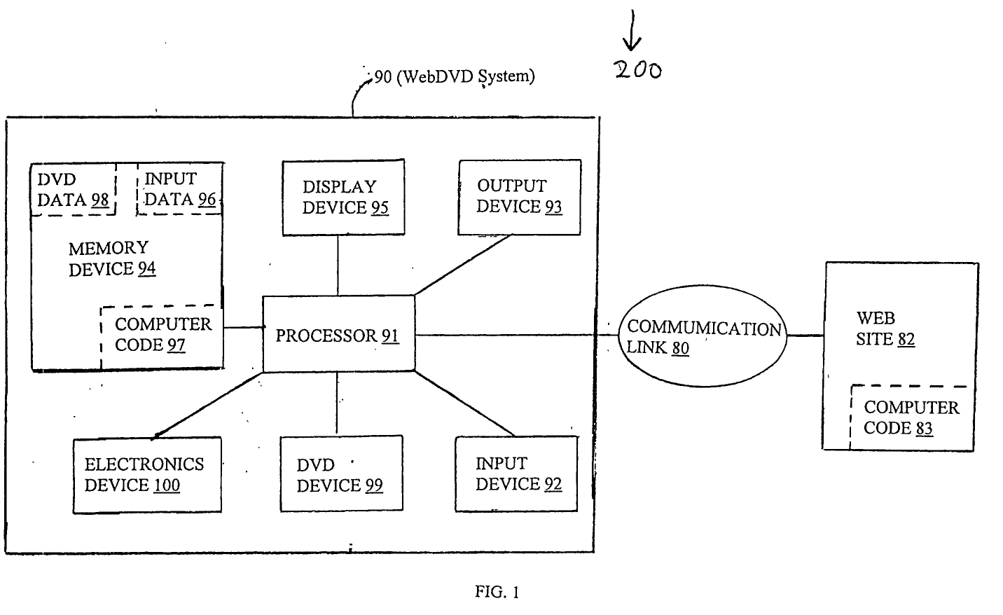

FIG. 1 depicts a network 200, comprising a WebDVD system 90 and a web site 82, in accordance with embodiments of the present invention. The WebDVD system 90 is linked to the web site 82 by a communication link 80. “DVD” stands for Digital Versatile Disc or Digital Video Disc. The communication link 80 may comprise the Internet, an Intranet, etc., to which the web site 82 is linked. The web site 82 includes a computer code 83 which may represent, or be comprised by, a web server of the web site 82. The web site 82 generates web content (e.g., web pages) which is understood herein to include any type of internet-based content, including any content available on a server connected to the Internet. The web site 82 may comprise, inter alia, any information stored on a internet connected server.

The WebDVD system 90 comprises a processor 91, a DVD device 99, an electronics device 100, an input device 92, a memory device 94, a display device 95, and an output device 93. The processor 91 is coupled to the communication link 80, the DVD device 99, the electronics device 100, the input device 92, the memory device 94, the display device 95, and the output device 93. In various embodiments, one or more of the preceding devices may be absent.

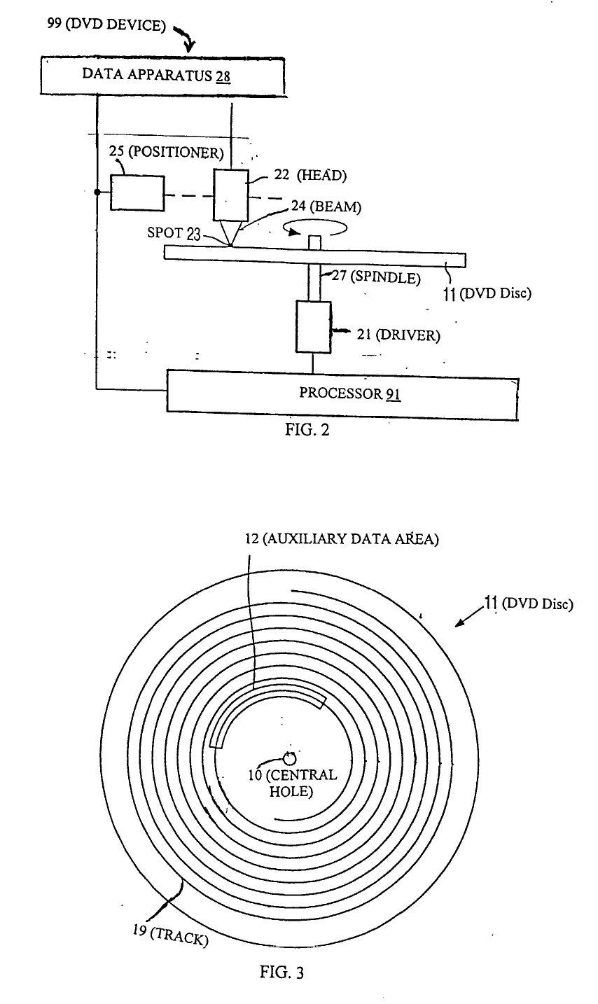

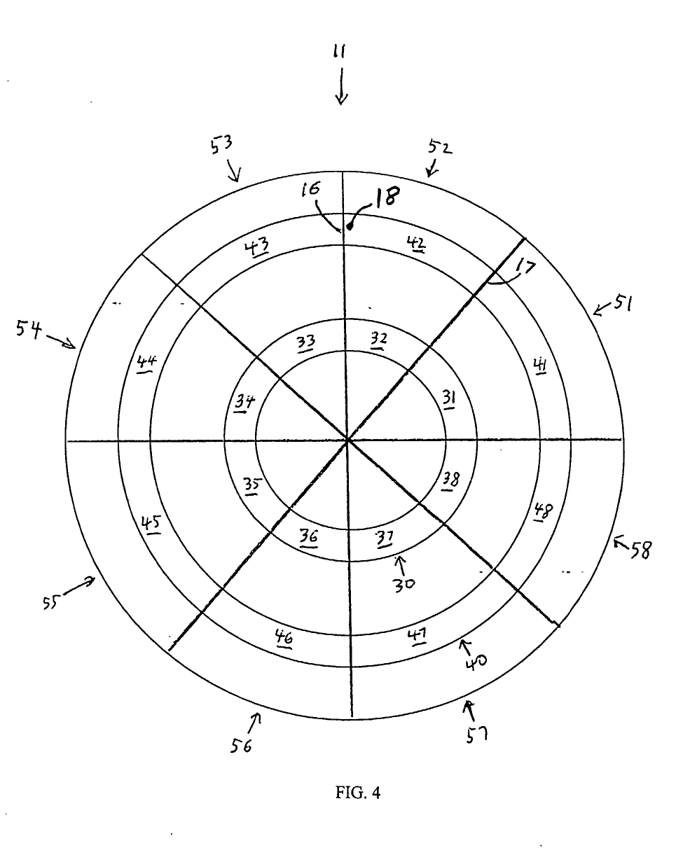

The DVD device 99 is a device or apparatus that reads and/or writes on a DVD disc. The DVD device 99 is shown in FIG. 2 as holding a DVD disc 11 and is described infra. The DVD disc 11 is shown in FIG. 3 and is described infra.

In FIG. 1, the electronics device 100 is one or more electronic devices that may be used in conjunction with the DVD device 99 and may be a component of an integrated electronics device (e.g., a consumer electronics device). Examples of pertinent consumer electronics devices include, inter alia, a video game player (e.g., Sony Playstation 2®), a DVD-VHS device that includes the DVD device 99 coupled to the electronics device 100 representing a VHS video cassette recorder, a stereo system that includes the DVD device 99 coupled the electronics device 100 representing stereo components. In a given embodiment, the electronics device 100 may be present or absent in the WebDVD system 90.

The memory device 94 may be, inter alia, a hard disk, a floppy disk, a magnetic tape, an optical storage (e.g., DVD or compact disc (CD): with Read/Write and/or Read Only capabilities), a dynamic random access memory (DRAM), a flash memory, a read-only memory (ROM), etc. The memory device 94 includes software, namely a computer code 97. The computer code 97 includes an algorithm for generating a decryption key to decrypt web content received from the web site 82, as described infra. The processor 91 executes the computer code 97. The memory device 94 may also include input data 96 which includes input used by the computer code 97. The memory device 94 may additionally include DVD data 98 which may comprise, inter alia, DVD data derived from a web page of a web site, DVD data derived from a DVD disc (e.g., the DVD disc 11 shown in FIGS. 2 and 3 described infra), etc.

The memory device 94 (or one or more additional memory devices not shown in FIG. 1) may be embodied as a readable medium for storing program code and data, and for reading program code and data. The memory device 94 may be, inter alia, a computer usable medium, a computer readable medium, a program storage device, a readable memory device, a data storage device, etc. The memory device 94 may have a readable program code (e.g., a computer readable program code) embodied therein and/or having other data stored therein, wherein the computer readable program code comprises the computer code 97. Generally, a computer program product (or, alternatively, an article of manufacture) of the computer system 90 may comprise said memory device 94.

The display device 95 is any device having a display screen (e.g., a television, a monitor, etc.).

The input device 92 may be, inter alia, a keyboard, a mouse, a joystick combinations thereof, etc.

The output device 93 represents one or more output devices such as, inter alia, a printer, a plotter, a computer screen, a magnetic tape, a removable hard disk, a floppy disk, etc. The output device 93 may display output from the computer code 97. The output device 93 may also express output from a DVD disc that is running in the DVD device 99. Accordingly, the output device may be an audible device such as a speaker. Of course, the DVD device 99 itself may include a speaker for audibly expressing subject content being played on a DVD disc. In a given embodiment, the output device 93 may be present or absent in the WebDVD system 90.

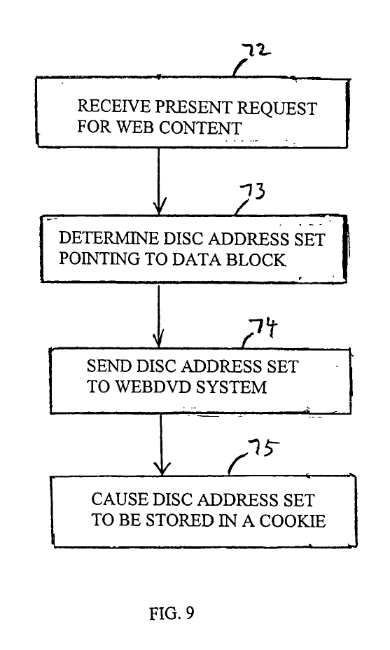

While FIG. 1 shows the WebDVD system 90 as a particular configuration of hardware and software, any configuration of hardware and software, as would be known to a person of ordinary skill in the art, may be utilized for the purposes stated in this patent application in conjunction with the particular computer system 90 of FIG. 9. For example, one or more additional multiple memory devices may be used instead of the single memory device 94. As another example, various components WebDVD system 90 may be directly coupled to each other (e.g., the DVD device 99 and the electronics device 100 may be directly coupled to each other such as in a single device).

The WebDVD system 90 may be configured in accordance with various embodiments including, inter alia, a DVD player embodiment, a computer system embodiment, and an integrated device embodiment.

In the DVD player embodiment, the WebDVD system 90 comprises a DVD player which includes: the DVD device 99, the processor 91, the input device 92, and the memory device 94. The DVD player may also internally include the display device 95, or be coupled to the display device 95 wherein the display device 95 is external to the DVD player yet is within the WebDVD system 90. As an external display device, the display device 95 may be a television or a monitor.

In the computer system embodiment, the WebDVD system 90 comprises a computer system which includes: the processor 91, the input device 92, the memory device 94, the output device 93, and the display device 95 (e.g., a computer monitor). The computer system may also internally include the DVD device 99, or be coupled to the DVD device 99 wherein the DVD device 99 is external to the computer system yet is within the WebDVD system 90.

In the integrated device embodiment, the WebDVD system 90 comprises an integrated device that includes: the DVD device 99, the electronics device 100 in the form of a consumer electronics device, the processor 91, the input device 92, and the memory device 94. The integrated device may also internally include the display device 95, or be coupled to the display device 95 wherein the display device 95 is external to the integrated device yet is within the WebDVD system 90. As an external display device, the display device 95 may be a television or a monitor. As stated supra, the integrated device may comprise a video game player, a DVDVHS device, a stereo system, etc.

FIG. 2 depicts the DVD device 99 of FIG. 1 on which a DVD disc 11 is placed, in accordance with embodiments of the present invention. The web site 82 of FIG. 1 is targeted by the DVD disc 11, which means that the WebDVD system 90 may have access to web content relating to the DVD disc 11 only when the DVD disc 11 in running on the DVD device 99. The DVD device 99 may be used for reading the DVD disc 11, writing to the DVD disc 11 (if the DVD disc 11 is a rewritable disc), or both. Accordingly, a read/write head 22 reads or writes data at the spot 23 on the DVD disc 11. The driver 21 rotates the DVD disc 11 on a spindle 27, and a positioner 25 moves the head 22 radially between the center and outer boundary of the DVD disc 11. When the DVD device 99 is used for reading the DVD disc 11, the head 22 serves as a read head and the data apparatus 28 retrieves the data read by the head 22. When the DVD device 99 is used for writing to the DVD disc 11, the head 22 serves as a write head and the data apparatus 28 distributes data from a data source (not shown) to the head 22 for subsequent writing. The DVD device 99 depicted in FIG. 2 is merely exemplary, and may be varied in any manner known to one of ordinary skill in the art for reading a DVD disc or writing to a DVD disc.

FIG. 3 depicts the DVD disc 11 of FIG. 2, in accordance with embodiments of the present invention. The DVD disc 11 has a central hole 10 that fits on the spindle 27 of FIG. 2. The DVD disc 11 is arranged in accordance with a spiral pattern of turns constituting substantially parallel tracks as illustrated by track 19. Information may be represented on the DVD disc 11 by optically detectable marks recorded along the track, e.g. pits and lands. The DVD disc 11 may have special regions or areas for recording particular types of information. For example, an auxiliary data area 12 may be used to store data other than the DVD subject content (e.g., movies) intended to be played by the WebDVD user. An example of such auxiliary data includes tables, pointers, format identification for the DVD subject content intended to be played by the WebDVD user, etc. The DVD subject content intended to be played by the WebDVD user may include video information, audio information, or both.

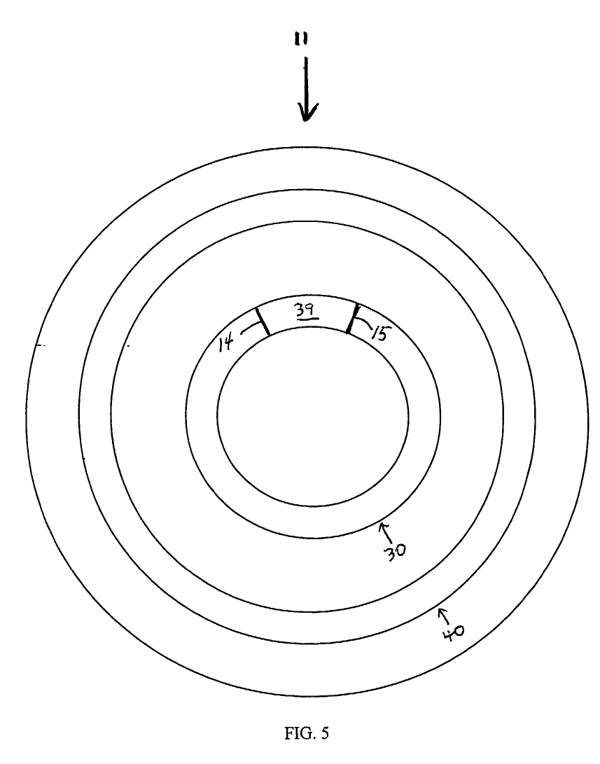

FIG. 4 depicts the DVD disc 11 of FIG. 3 divided into angular sectors 51-58, in accordance with embodiments of the present invention. FIG. 4 also shows representative tracks 30 and 40. Track 30 is divided into sectors 31-38 corresponding to the angular sectors 51-58, respectively. Track 40 is divided into sectors 41-48 corresponding to the angular sectors 51-58, respectively. Sector 42 of track 40 is bounded by boundary lines 16 and 17, which define the end points of sector 42. Sector 42 of track 40 begins at location 18 and is characterized by a sector address at location 18. A data block on a track (e.g., track 40 or track 50) may comprise a fraction of a sector, a full sector, or more than one sector. As examples, a data block may: fill sector 42 (1 sector); fill sectors 35-37 (3 sectors); fill sector 35 and a half of sector 36 that is contiguous with sector 35 (1 ½ sectors); etc.

A data block on the DVD disc 11 may be a physical data block or a logical data block. A physical data block is a data block whose extent is defined by disc addresses. For example, a data block that fits into sector 42 and whose extent is defined by the boundaries 16 and 17 of sector 42 is a physical data block. Since the boundaries 16 and 17 are defined by actual disc addresses, the boundaries 16 and 17 may be viewed as physical boundaries that define the extent of the physical data block that fills sector 42. Note that the extent of a physical data block may also be viewed as the length of the physical data block expressed as the number of bits (or bytes or similar units) in the physical data block.

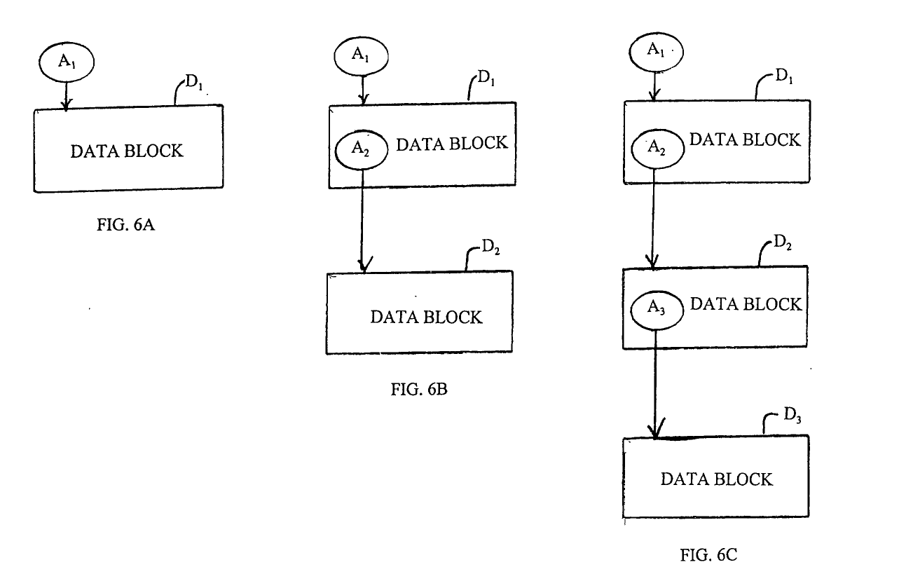

In contrast, FIG. 5 depicts a logical data block 39 within the DVD disc 11 of FIG. 4, in accordance with embodiments of the present invention. The sector boundaries shown in FIG. 4 are omitted in FIG. 5 for simplicity. The logical data block 39 encompasses a group of linked data such as in a record, file, array, etc. The logical data block 39 exists between boundaries 14 and 15, which are not required to be aligned with sector boundaries. Hence, the boundaries 14 and 15 may viewed as logical boundaries that define the extent of the logical data block 39. Note that the extent of a logical data block may also be viewed as the length of the logical data block expressed as the number of bits (or bytes or similar units) in the logical data block, or expressed in terms of the number of bits (or bytes or similar units) in the record, file, array, etc.

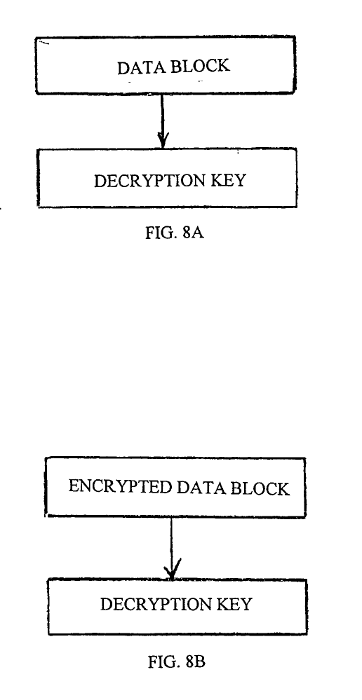

A data block could comprise an Error Correction Code (ECC) block. An ECC block has a known size. As an example, an EEC block on DVD may comprise 16 physical blocks such that each physical block of the ECC block includes 2048 bytes of user data, for a total of 32,768 bytes in the ECC block. An ECC block, or one or more physical block within the ECC block, could be the data block that is used to generate a decryption key. See FIG. 7 and accompanying description infra for a discussion of how a decryption key may be generated in accordance with the present invention.

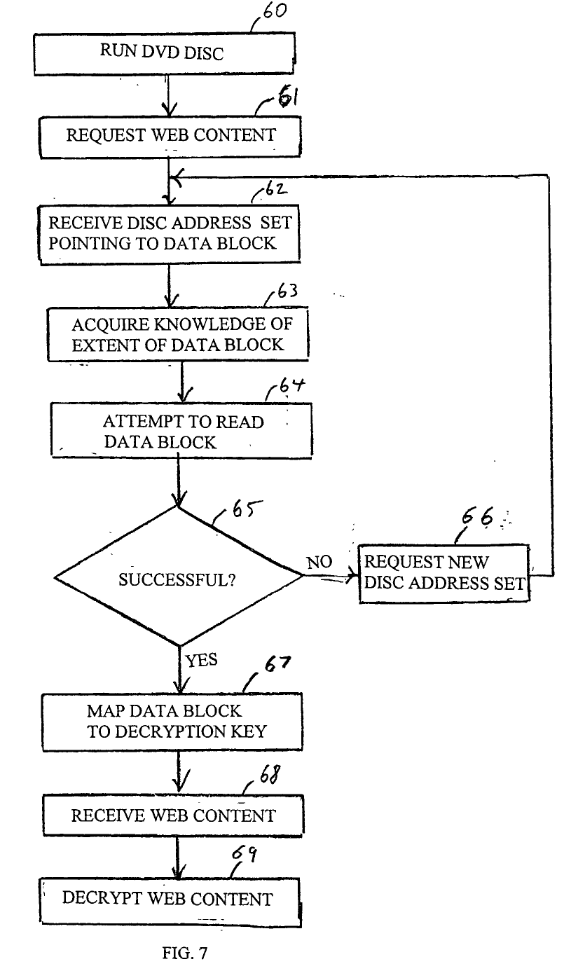

FIGS. 6A-6C illustrate direct and indirect pointers to data blocks of a disc, in accordance with embodiments of the present invention. FIG. 6A illustrates a direct pointer, and FIGS. 6B-6C illustrate indirect pointers.

FIG. 6A depicts a direct pointer to a data block of a DVD disc, in accordance with embodiments of the present invention. In FIG. 6A, a disc address A₁ points to the beginning of data block D₁ of the DVD disc. Data block D₁ may be a physical data block or a logical data block. In FIG. 6A, the data block D₁ contains data. The disc address A₁ points directly to the data block D₁ or to the data contained in the data block D1.

FIG. 6B depicts a first-level indirect pointer to a data block of a DVD disc, in accordance with embodiments of the present invention. The disc address A₁ points to the beginning of data block D₁ of the DVD disc, as in FIG. 6A Data block D₁ may be a physical data block or a logical data block. In FIG. 6B, the data block D₁ includes disc address A₂ which points to the beginning of data block D₂ of the DVD disc. Data block D₂ may be a physical data block or a logical data block. In FIG. 6B, the data block D₂ contains data. The disc address A₁ points indirectly (through the disc address A₂) to the data block D₂ or to the data contained in the data block D₂. In FIG. 6B, the disc address A₁ is a first-level indirect pointer to the data block D₂, because one auxiliary pointer (i.e., A₂) is required for A₁ to point to D₂.

FIG. 6C depicts a second-level indirect pointer to a data block of a DVD disc, in accordance with embodiments of the present invention. The disc address A₁ points to the beginning of data block D₁ of the DVD disc, as in FIG. 6A or FIG. 6B. Data block D₁ may be a physical data block or a logical data block. In FIG. 6C, the data block D₁ includes disc address A₂ which points to the beginning of data block D₂ of the DVD disc. Data block D₂ may be a physical data block or a logical data block. In FIG. 6C, the data block D₂ includes disc address A₃ which points to the beginning of data block D₃ of the DVD disc. Data block D₃ may be a physical data block or a logical data block. The disc address A₁ points indirectly (through the disc addresses A₂ and A₃) to the data block D₃ or to the data contained in the data block D₃. In FIG. 6C, the disc address A, is a second-level indirect pointer to the data block D₃, because two auxiliary pointers (i.e., A₂ and A₃) are required for A₁ to point to D₃.

The data within a data block need not be contiguously distributed on a DVD disc. For example, a first contiguous portion of a data block could comprise a pointer (e.g., an address pointer such as A₂ or A₃ as described supra in conjunction with FIGS. 6B and 6C) that points to a second contiguous portion of the data block, wherein said first and second contiguous portions of the data block are not contiguous with respect to each other. In general, a data block comprises M contiguous portions of the DVD disc such that M is a positive integer of at least 1. If M is at least 2, then the M contiguous portions may be linked by pointers (e.g., address pointers). The M contiguous portions may be alternatively linked in any other way known to a person of ordinary skill in the art. For example the M contiguous pointers may each represent a record of a file, or a row of a table, such that each of the M contiguous pointers is independently identified by its own disc address. For the case M>1 such that more than one disc address is required to located a data block on the DVD disc, a disc address set comprising a plurality of disc addresses together with the extent of the data block (which may be expressed in terms of the extent of each of the M contiguous portions) is utilized by the WebDVD system 90 to locate the data block in its entirety.

FIG. 7 is a flow chart with steps 60-69 that depict decryption of web content associated with the DVD disc 11 through mapping a data block to a decryption key, in accordance with embodiments of the present invention. The reader is also referred to FIGS. 1 and 2 for reference numerals referred to in the following description of FIG. 7. In step 60, the WebDVD system 90 runs the DVD disc 11 on the DVD device 99, wherein the DVD device 99 is comprised by the WebDVD system 90. As stated supra in conjunction with FIG. 2, the web site 82 is targeted by the DVD disc 11, which means that the WebDVD system 90 may have access to web content relating to the DVD disc 11 only when the DVD disc 11 in running on the DVD device 99. Note that the DVD device 99 is linked by the communication link 80 to the web site 82.

In step 61, the WebDVD system 90 requests web content from the web site 82.

In step 62, the WebDVD system 90 receives, from the web site 82, a disc address set on the DVD disc 11, wherein the disc address set directly or indirectly points to a data block on the DVD disc 11. The data block may be a physical data block or a logical data block. As described supra, the data block may be contiguous or non-contiguous. Thus, the disc address set that points to the data block is one or more disc addresses as necessary to determine the location of the data in the data block. If data block consists of one contiguous portion or if the data block comprises a plurality of non-contiguous portions linked exclusively by address pointers as described supra, then the disc address set received by the WebDVD system 90 from the web site 82 requires no more than one disc address. In some applications, however, the disc address set will need two or more disc addresses to determine the location of the data in the data block, such that different disc addresses in the disc address set point to different contiguous portions of the data block. If the disc address set includes at least two disc addresses, then the disc address set is said to directly point to the data block if each disc address of the disc address set directly points to a portion of the data block. If the disc address set includes at least two disc addresses, then the disc address set is said to indirectly point to the data block if each disc address of the disc address set indirectly points to a portion of the data block.

In step 63, the WebDVD system 90 acquires knowledge of the extent of the data block, wherein the data block is determined by the disc address set and the extent of the data block. The extent of the data block may have a predetermined value that is stored at a physical or logical location within the WebDVD system, such as in the memory device 94, such that acquiring knowledge of the extent of the data block comprises accessing the predetermined extent from the physical or logical location. A physical location is a location within a physical data block, while a logical location is a location within a logical data block. Alternatively, the WebDVD system 90 may acquires knowledge of the extent of the data block from the web site 82.

In step 64, the WebDVD system 90 attempts to read the data block. The attempt to read the data block may or may not be successful. For example, the attempt to read the data block from a scratched location on the disc may not be successful.

Step 65 is a decision block taking alternative action depending on whether the attempt to read the data block in step 64 was successful. If NO (i.e., the attempt to read the data block in step 64 was not successful), then the WebDVD system 90 request a new disc address set in step 66 to replace the previously received disc address set, wherein the new disc address set will point to a new data block on the DVD disc 11. The request for the new disc address set is followed by a maximum of N repetitions of steps 62-64 until the attempt to read the data block in step 64 is successful, wherein N is at least 0. The embodiment of N=0 represents a case in which a request for a new disc address set is not permitted such that steps 64 and 65 are effectively deleted from the flow chart in FIG. 7. IF N>0 then a “new disc address set requesting feature” is said to operative on the WebDVD system 90. If N=0, the “new disc address set requesting feature” is not operative on the WebDVD system 90. If YES (i.e., the attempt to read the data block in step 64 is successful), then step 67 is executed.

In step 67, the WebDVD system 90 maps the data block to a decryption key by a defined function. The defined function may be an identity function, which effectively maps the data block to itself with no change in the data block. Thus with an identity function, the decryption key is the data block itself. Alternatively, the defined function may be a function that is not an identity function, which effectively maps the data block to the encryption key that differs from the data block. Any defined function may be used. As an example, the defined function may select a subset of bits from the data block. As another example, the defined function may be a hashing function of the bits (or groups of bits) in the data block.

After the decryption key is generated from mapping the data block using the defined function, then through use of the decryption key, the WebDVD system 90 may decrypt the web content (see step 69) received from the web site 82 (see step 68). The web content may be received from the web site 82 after or before the decryption key is generated.

While particular process steps in a particular order are shown in FIG. 7, the process steps of FIG. 7 may be varied in substance and order as would be known or obvious to a person of ordinary skill in the art to generate a decryption key for decrypting the web content. For example, step 68 (receive web content) may precede step 62 (receive address set pointing to data block).

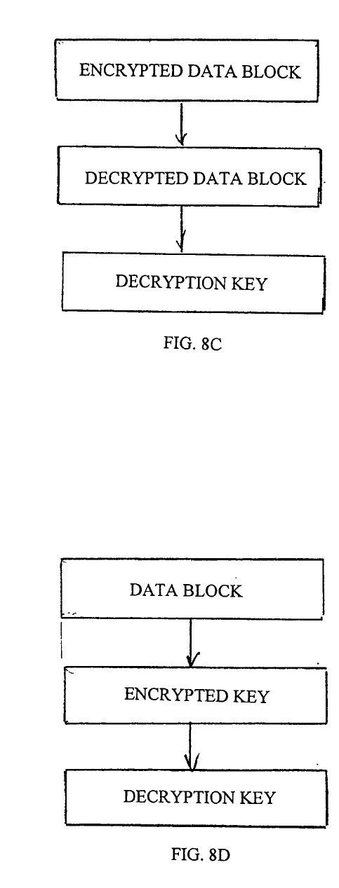

FIGS. 8A-8D depict embodiments of the mapping of the data block to the decryption key in step 69 of FIG. 7, in accordance with embodiments of the present invention. FIG. 8A shows the mapping of the data block to the decryption key generally. The data block being attempted to be read in step 64 may be encrypted or may not be encrypted. As shown in FIG. 8B, if the data block is encrypted, the mapping in step 67 may directly map the encrypted data block to the decryption key by the defined function. Alternatively as shown in FIG. 8C, if the data block is encrypted, the mapping in step 67 may first decrypt the data block to generate a decrypted data block, followed by mapping the decrypted data block to the decryption key by the defined function. As shown in FIG. 8D, another embodiment is to map the data block to an encrypted key by the defined function, followed by decrypting the encrypted key to generate the decryption key. For example, the encrypted key could be decrypted using a DVD encryption system (e.g., Content Scrambling System (CSS)) in current use to generate the final decryption key.

The preceding steps 60-69 shown in FIG. 7, and the mapping embodiments shown in FIGS. 8A-8D, may be executed by the computer code 97, and algorithms thereof, in the memory device 94.

FIG. 9 is a flow chart with steps 72-75 that depict the web site 82 sending a DVD disc address set to the WebDVD system 90 for subsequent generation of a decryption key, in accordance with embodiments of the present invention. In step 72, the web site 82 receives a present request from the WebDVD system 90 for web content associated with the DVD disc 11 that is running on the DVD device 99 comprised by the WebDVD system 90, which corresponds to steps 60 and 61 of FIG. 7. The DVD device 99 is linked by the communication link 80 to the web site 82. The web site 82 is targeted by the DVD disc 11 and the WebDVD system 90 may have access to the web content from the web site 82 only when the DVD disc 11 is running on the DVD device 99.

In step 73, the web site 82 determines a disc address set on the DVD disc 11, wherein the disc address set points to a data block on the DVD disc 11, wherein the data block is adapted to be mapped to the decryption key by a defined function, and wherein the decryption key is adapted to be used by the WebDVD system 90 to decrypt the web content.

In step 74, the web site 82 sends the disc address set to the WebDVD system 90, which corresponds to step 62 of FIG. 7.

In step 75, the web site 82 causes the disc address set to be stored in a cookie in the memory device 84 of the WebDVD system 90. A cookie is a text string within a text file, typically called a “cookie file” and is stored on the web user's machine (e.g., computer; DVD device, etc.). As an example of using a cookie, the web site 82 may have the disc address set be a parameter of a “Set-Cookie” command transmitted by the web site 82 to the WebDVD system 90. Step 75 is optional and is available to the web site 82 to enable the web site 82 to know what disc address set the web site 82 sent to the WebDVD system 90 the last time that the WebDVD system 90 accessed the web site 82, since the cookie is be sent to web site 82 in response to each request from the WebDVD system 90 for web content. Such request for the web content is received by the web site 82 in step 72. Information on cookies may be obtained from, inter alia, RFC2965 (see http://www.ietf.org/rfc/rfc2965.txt).

While particular process steps in a particular order are shown in FIG. 9, the process steps of FIG. 9 may be varied in substance and order as would be known or obvious to a person of ordinary skill in the art to generate a decryption key for decrypting the web content. For example, step 75 (cause disc address set to be stored in a cookie) may be eliminated as discussed supra.

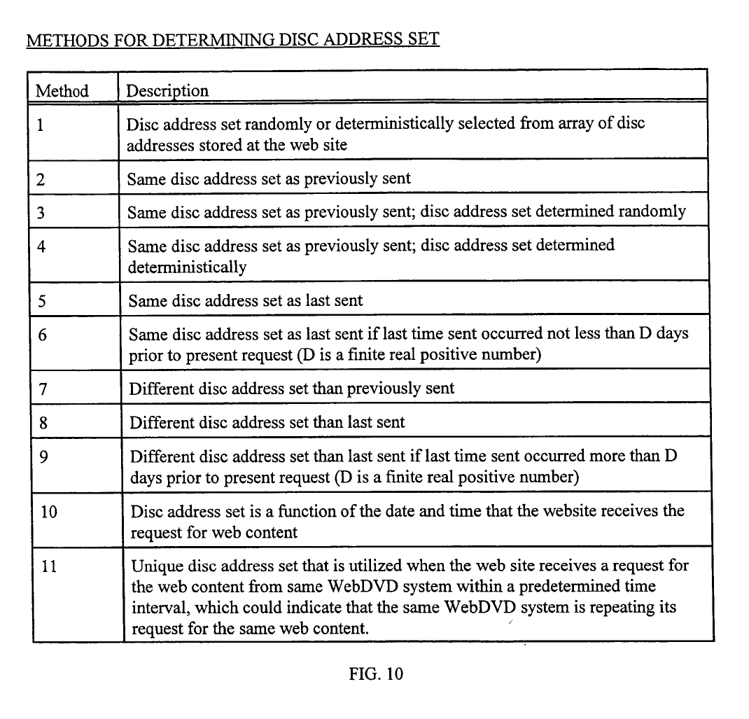

FIG. 10 is a table showing Methods 1-11 for determining a DVD disc address set in step 73 of FIG. 9, in accordance with embodiments of the present invention.

Method 1 randomly or deterministically selects a disc address set from an collection of disc addresses or a collection of disc address sets (e.g., an array of disc addresses or an array of disc address sets) stored at the web site 82. An example of random selection of the disc address set is picking each disc address of the disc address set from a uniform probability distribution. Another example of random selection of the disc address set is picking each disc address of the disc address set from a normal probability distribution. An example of deterministic selection of a disc address set is marching sequentially through an array of disc address sets by selecting the next sequential disc address set in the array of disc address sets the next time a disc address set is to be selected. Accordingly, the web site 82 can maintain a number of copies of the same web content with different disc addresses sets and associated decryption keys, so that for the same DVD system 90, a different decryption key can be supplied to the same DVD system 90 for each request for the web content by the same DVD system 90. It is up to the web site 82 to decide how many disc addresses sets to currently support and how often to change the disc address sets. Each change of disc address set requires the corresponding web content to be re-encrypted. The use of multiple disc address sets at the web site 82, or more generally changes of disc address sets for successive disc addresses sets supplied to the same DVD system 90 which occur in other Methods described infra, makes ineffective any caching of disc address sets or associated decryption keys at the DVD system 90. Thus the web site 82 can deliberately choose a different disc address set to ensure that the disc address set or associated decryption key has not been effectively cached at the DVD system 90. As described supra, cookies can be used to store disc addresses sets.

Method 2 determines the DVD disc address set to be a same address set that was sent by the web site 82 to the DVD system 90 at a previous time when the DVD system 90 requested the web content.

Method 3 is the same as method 1, except that the previous time is randomly selected from more than one previous time when the DVD system 90 requested the web content. An example of random selection of the previous time is picking from a uniform probability distribution of the previous times when the DVD system 90 requested the web content. Another example of random selection of the previous time is picking from a weighted probability distribution based on selective weighting of the previous times when the DVD system 90 requested the web content.

Method 4 is the same as method 1, except that the previous time is deterministically selected from more than one previous time when the DVD system 90 requested the web content. An example of deterministic selection of the previous time is selection of the next to last previous times when the DVD system 90 requested the web content.

Method 5 determines the DVD disc address set to be a same address set that was sent by the web site 82 to the DVD system 90 at a last time when the DVD system 90 requested the web content.

Method 6 determines the DVD disc address set to be a same address set that was sent by the web site 82 to the DVD system 90 at a last time when the DVD system 90 requested the web content if the last time occurred not less than D days prior to the present request, wherein D is a finite positive real number.

Method 7 determines the DVD disc address set to be a different address set from a previous address set that was sent by the web site 82 to the DVD system 90 at a previous time the DVD system 90 requested the web content.

Method 8 determines the DVD disc address set to be a different address set from a last address set that was sent by the web site 82 to the DVD system 90 at a last time the DVD system 90 requested the web content.

Method 9 determines the DVD disc address set to be a different address set from a last address set that was sent by the web site 82 to the DVD system 90 at a last time the DVD system 90 requested the web content if the last time occurred more than D days prior to the present request, wherein D is a finite positive real number.

Method 10 determines a disc address (or each disc address) of DVD disc address set to be a function of the date and time that the web site 82 received the request for web content.

Method 11 is determines a unique DVD disc address and may be employed for, inter alia, the special case in which the WebDVD system 90 requests a new disc address set following a previously unsuccessful attempt to read a data block (see steps 64-66 in FIG. 7). Method 11 determines a unique DVD disc address set that has never been used and is intended not to be used again in the future for the WebDVD system 90, in recognition of the possibility that the user of the WebDVD system 90 may invoke the request for a new disc address set for an improper purpose such as for, inter alia, effectively caching either the previous disc address set received or the new disc address set to be received. With method 11, the web site 82 may decide that the unique disc address set should be utilized when the web site receives a request for the web content from WebDVD system within a predetermined time interval (e.g., 1 minute, 5 minutes, 30 minutes, etc.) following a prior request received from the same WebDVD system, which could indicate that the same WebDVD system is repeating its request for the same web content in accordance with steps 64-66 in FIG. 7.

In practice, the web site 82 may choose to have the addresses of the disc address set be close to the center of the disc (e.g., close to the central hole 10 in FIG. 3), since startup information may be stored close to the center of the disc. Thus, having the addresses of the disc address set be close to the center of the disc may reduce the startup time if the disc driver 21 (see FIG. 2) only needs to make a small jump to read the disc address set or the data block pointed to by the disc address set.

The preceding steps 72-75 shown in FIG. 9, and methods for determining the DVD disc address set in FIG. 10, may be executed by the computer code 83, and algorithms thereof, in the web site 82 (e.g., within the web server of the web site 82).

The computer code 83 (and/or web server) of the web site 82 may have access the DVD content on the DVD disc 11, either through use of an actual DVD drive together with the DVD disc 11 or through use of bit copy of the DVD disc 11. This enables the computer code 83 (and/or web server) of the web site 82 to automatically generate other disc address sets and associated encryption/decryption keys and to re-encrypt the web content with said associated encryption keys and in correspondence with said other disc address sets. Each of said other disc address sets points to a corresponding data set on the DVD disc 11 for subsequent transmission of the other disc address set to some WebDVD system (e.g., the WebDVD system 90 or another WebDVD system) that subsequent requests the web content. Said automatic generation may be implemented periodically, at fixed dates and times, as triggered by a pre-defined condition or event, etc.

Based on the embodiments described herein, the present invention provides copy protection of DVD-related web content.

While the embodiments described herein are expressed in terms of a DVD disc (e.g., the DVD disc 11 of FIGS. 2 and 3), the present invention, as illustrated herein by the DVD disc 11, is not limited to DVD discs. The scope of the present invention generally includes any medium having any physical disc format (e.g. CD, DVD, Blu-ray, etc.), including ROM, Write once, and Rewritable discs. The present invention generally applies to discs that include different application formats (e.g. video, audio, games, etc.).

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A decryption method for decrypting web content associated with a DVD disc, comprising the steps of:
running, by a WebDVD system, the DVD disc on a DVD device comprised by the WebDVD system, wherein the DVD device is linked by a communication link to a web site that is targeted by the DVD disc, and wherein the WebDVD system may have access to the web content only when the DVD disc in running on the DVD device;
requesting, by the WebDVD system, the web content from the web site;
receiving, by the WebDVD system from the web site, a disc address set on the DVD disc, wherein the disc address set points to a data block on the DVD disc;
acquiring knowledge, by the WebDVD system, of the extent of the data block, wherein the data block is determined by the disc address set and the extent;
attempting by the WebDVD system to read the data block, and if a new disc address set requesting feature is operative on the WebDVD system and if said attempting is not successful then: directing the web site to send a new disc address set to replace the previously received disc address set for pointing to a new data block on the DVD disc, followed by a maximum of N repetitions of said receiving, acquiring, and attempting steps until said attempting is successful, wherein N is at least 1; and
mapping the data block to a decryption key by a defined function if said attempting is successful.

2. The method of claim 1, further comprising:
receiving, by the WebDVD system, the web content from the web site; and
decrypting, by the WebDVD system, the web content through use of the decryption key.

3. The method of claim 1, wherein the data block in the attempting step is not encrypted.

4. The method of claim 1, wherein the data block in the attempting step is encrypted, and wherein said mapping comprises mapping the encrypted data block to the decryption key by the defined function.

5. The method of claim 1, wherein the data block in the attempting step is encrypted, and wherein said mapping comprises:
decrypting the data block to generate a decrypted data block; and
mapping the decrypted data block to the decryption key by the defined function.

6. The method of claim 1, wherein said mapping comprises:
mapping the data block to an encrypted key by the defined function; and
decrypting the encrypted key to generate the decryption key.

7. The method of claim 1, wherein the defined function is an identity function.

8. The method of claim 1, wherein the defined function is not an identity function.

9. The method of claim 1, wherein the defined function has a dependence on the date and time at which the mapping is performed.

10. The method of claim 1, wherein the disc address set directly points to the data block.

11. The method of claim 1, wherein the disc address set indirectly points to the data block.

12. The method of claim 1, wherein the extent has a predetermined value that is stored at a physical location within the WebDVD system, and wherein said acquiring knowledge comprises accessing the extent from said physical location.

13. The method of claim 1, wherein the extent has a predetermined value that is stored at a logical location within the WebDVD system, and wherein said acquiring knowledge comprises accessing the extent from said logical location.

14. The method of claim 1, wherein said acquiring knowledge comprises receiving the extent from the web site.

15. The method of claim 1, wherein the extent is the length of the data block.

16. The method of claim 1, wherein the extent is defined by a physical or logical boundary on the DVD disc.

17. The method of claim 1, wherein the WebDVD system comprises a WebDVD player that includes the DVD device.

18. The method of claim 17, wherein the WebDVD player includes a display device for displaying data relating to the DVD disc.

19. The method of claim 18, wherein the display device is external to the WebDVD player.

20. The method of claim 19, wherein the display device is a television.

21. The method of claim 1, wherein the WebDVD system comprises a computer system that couples the DVD device to the communication link, and wherein the DVD device is external to the computer system.

22. The method of claim 1, wherein the WebDVD system comprises a computer system that couples the DVD device to the communication link, and wherein the DVD device is within the computer system.

23. The method of claim 1, wherein the WebDVD system further includes an electronics device that is adapted to operate in conjunction with the DVD device.

24. The method of claim 23, wherein a consumer electronics device comprises the electronics device coupled to the DVD device.

25. The method of claim 1, wherein the communication link comprises the Internet.

26. A method for transmitting, by a web site to a WebDVD system, information that may be used by the WebDVD system to generate a decryption key, comprising the steps of:
receiving, by the web site, a present request from the WebDVD system for web content associated with a DVD disc that is running on a DVD device comprised by the WebDVD system, wherein the DVD device is linked by a communication link to the web site, wherein the web site is targeted by the DVD disc, and wherein the WebDVD system may have access to the web content only when the DVD disc is running on the DVD device;
determining, by the web site, a disc address set on the DVD disc, wherein the disc address set points to a data block on the DVD disc, wherein the data block is adapted to be mapped to the decryption key by a defined function, and wherein the decryption key is adapted to be used by the WebDVD system to decrypt the web content; and
sending, by the web site, the disc address set to the WebDVD system.

27. The method of claim 26, wherein the determining determines the same disc address set that was sent by the web site to the DVD system at a previous time when the DVD system requested the web content.

28. The method of claim 27, wherein the determining includes randomly selecting the previous time from more than one previous times when the DVD system requested the web content.

29. The method of claim 27, wherein the determining includes deterministically selecting the previous time from more than one previous times when the DVD system requested the web content.

30. The method of claim 26, wherein the determining determines the same disc address set that was sent by the web site to the DVD system at a last time when the DVD system requested the web content.

31. The method of claim 26, wherein the determining determines the same disc address set that was sent by the web site to the DVD system at a last time the DVD system requested the web content if the last time occurred not less than D days prior to the present request, and wherein D is a finite positive real number.

32. The method of claim 26, wherein the determining determines a different disc address set from a previous disc address set that was sent by the web site to the DVD system at a previous time the DVD system requested the web content.

33. The method of claim 26, wherein the determining determines a different disc address set from a last disc address set that was sent by the web site to the DVD system at a last time the DVD system requested the web content.

34. The method of claim 26, wherein the determining determines a different disc address set from a last disc address set that was sent by the web site to the DVD system at a last time the DVD system requested the web content if the last time occurred more than D days prior to the present request, and wherein D is a finite positive real number.

35. The method of claim 26, wherein the determining includes randomly selecting the disc address set through randomly sampling from a collection of disc addresses stored at the web site.

36. The method of claim 26, wherein the determining includes deterministically selecting the disc address set through deterministically selecting disc addresses from a collection of disc addresses stored at the web site.

37. The method of claim 26, wherein if the web site has received the request from the WebDVD system for the web content within a predetermined time interval following a prior request received from the WebDVD system, then the determining includes having the disc address set be a unique disc address set that has never been used and is intended not to be used again in the future for the WebDVD system.

38. The method of claim 26, wherein the disc address set directly points to the data block.

39. The method of claim 26, wherein the disc address set indirectly points to the data block.

40. The method of claim 26, wherein a disc address of the disc address set is a function of the date and time at which the request is received by the web site from the WebDVD system.

41. The method of claim 26, further comprising transmitting, by the web site to the WebDVD system, the extent of the data block, wherein the data block is determined by the disc address set and the extent.

42. The method of claim 26, further comprising causing, by the web site, the disc address set to be placed in a cookie that may be stored in the WebDVD system.

43. The method of claim 26, wherein the WebDVD system comprises a WebDVD player that includes the DVD device.

44. The method of claim 43, wherein the WebDVD player includes a display device for displaying data relating to the DVD disc.

45. The method of claim 44, wherein the display device is external to the WebDVD player.

46. The method of claim 26, wherein the WebDVD system comprises a computer system that couples the DVD device to the communication link, and wherein the DVD device is external to the computer system.

47. The method of claim 26, wherein the WebDVD system comprises a computer system that couples the DVD device to the communication link, and wherein the DVD device is within the computer system.

48. The method of claim 26, wherein the WebDVD system further includes an electronics device that is adapted to operate in conjunction with the DVD device.

49. The method of claim 26, further comprising automatically generating, by the web site:
another disc address set that points to a corresponding data set on the DVD disc for subsequent transmission of the another disc address set to some WebDVD system that subsequent requests said web content; and
a re-encryption of said web content in correspondence with said another disc address set.

50. The method of claim 26, wherein the communication link comprises the Internet.

51. A network, comprising a WebDVD system, wherein the WebDVD system is adapted to:
request, from a web site targeted by a DVD disc, web content associated with the DVD disc, wherein the DVD disc is running on a DVD device comprised by the WebDVD system, wherein the DVD device is linked by a communication link to the web site, and wherein the WebDVD system may have access to the web content only when the DVD disc is running on the DVD device;
receive from the web site a disc address set that points to a data block of the DVD disc;
acquire knowledge of the extent of the data block, wherein the data block is determined by the disc address set and the extent;
attempt to read the data block, and if a new disc address set requesting feature is operative on the WebDVD system and if said attempt to read the data block is not successful then: direct the web site to send a new disc address set to replace the previously received disc address set to point to a new data block on the DVD disc, and repeat a maximum of N times said receive, acquire, and attempt until said attempt is successful, wherein N is at least 1; and
map the data block to a decryption key by a defined function if said attempt is successful, wherein the decryption key may be used by the WebDVD system to decrypt the web content.

52. The network of claim 51, wherein the WebDVD system is further adapted to:
receive the web content from the web site; and
decrypt the web content through use of the decryption key.

53. The network of claim 51, wherein the WebDVD system is adapted to receive the disc address set such that upon receipt of the disc address set by the web site the data block is not encrypted.

54. The network of claim 51, wherein the WebDVD system is adapted to receive the disc address set such that upon receipt of the disc address set by the web site the data block is encrypted, and wherein to map comprises to map the encrypted data block to the decryption key by the defined function.

55. The network of claim 51, wherein the WebDVD system is adapted to receive the disc address set such that upon receipt of the disc address set by the web site the data block is encrypted, and wherein to map comprises:
to decrypt the data block to generate a decrypted data block; and
to map the decrypted data block to the decryption key by the defined function.

56. The network of claim 51, wherein to map comprises:
to map the data block to an encrypted key by the defined function; and
to decrypt the encrypted key to generate the decryption key.

57. The network of claim 51, wherein the defined function is an identity function.

58. The network of claim 51, wherein the defined function is not an identity function.

59. The network of claim 51, wherein the defined function has a dependence on the date and time at which the data block is mapped.

60. The network of claim 51, wherein the disc address set directly points to the data block.

61. The network of claim 51, wherein the disc address set indirectly points to the data block.

62. The network of claim 51, wherein the extent has a predetermined value that is stored at a physical location within the WebDVD system, and wherein to acquire knowledge comprises to access the extent from said physical location.

63. The network of claim 51, wherein the extent has a predetermined value that is stored at a logical location within the WebDVD system, and wherein to acquire knowledge comprises to access the extent from said logical location.

64. The network of claim 51, wherein to acquire knowledge comprises to receive the extent from the web site.

65. The network of claim 51, wherein the extent is the length of the data block.

66. The network of claim 51, wherein the extent is defined by a physical or logical boundary on the DVD disc.

67. The network of claim 51, wherein the WebDVD system comprises a WebDVD player that includes the DVD device.

68. The network of claim 67, wherein the WebDVD player includes a display device for displaying data relating to the DVD disc.

69. The network of claim 68, wherein the display device is external to the WebDVD player.

70. The network of claim 69, wherein the display device is a television.

71. The network of claim 51, wherein the WebDVD system comprises a computer system that couples the DVD device to the communication link, and wherein the DVD device is external to the computer system.

72. The network of claim 51, wherein the WebDVD system comprises a computer system that couples the DVD device to the communication link, and wherein the DVD device is within the computer system.

73. The network of claim 51, wherein the WebDVD system further includes an electronics device that is adapted to operate in conjunction with the DVD device.

74. The network of claim 73, wherein a consumer electronics device comprises the electronics device coupled to the DVD device.

75. The network of claim 51, wherein the communication link comprises the Internet.

76. A network, comprising a web site, wherein the web site is adapted to:
receive a present request from a WebDVD system for web content associated with a DVD disc that is running on a DVD device comprised by the WebDVD system, wherein the DVD device is linked by a communication link to the web site, wherein the web site is targeted by the DVD disc, and wherein the WebDVD system may have access to the web content only when the DVD disc is running on the DVD device;
determine a disc address set on the DVD disc, wherein the disc address set points to a data block on the DVD disc, wherein the data block is adapted to be mapped to a decryption key by a defined function, and wherein the decryption key is adapted to be used by the WebDVD system to decrypt the web content; and
send the disc address set to the WebDVD system.

77. The network of claim 76, wherein to determine includes to determine the same disc address set sent by the web site to the DVD system at a previous time when the DVD system requested the web content.

78. The network of claim 77, wherein to determine includes to randomly select the previous time from more than one previous times when the DVD system requested the web content.

79. The network of claim 77, wherein to determine includes to deterministically select the previous time from more than one previous times when the DVD system requested the web content.

80. The network of claim 76, wherein to determine includes to determine the same disc address set sent by the web site to the DVD system at a last time when the DVD system requested the web content.

81. The network of claim 76, wherein to determine includes to determine the same disc address set sent by the web site to the DVD system at a last time the DVD system requested the web content if the last time is not less than D days prior to the present request, and wherein D is a finite positive real number.

82. The network of claim 76, wherein to determine includes to determine a different disc address set from a previous disc address set sent by the web site to the DVD system at a previous time the DVD system requested the web content.

83. The network of claim 76, wherein to determine includes to determine a different disc address set from a last disc address set sent by the web site to the DVD system at a last time the DVD system requested the web content.

84. The network of claim 76, wherein to determine includes to determine a different disc address set from a last disc address set sent by the web site to the DVD system at a last time the DVD system requested the web content if the last time is more than D days prior to the present request, and wherein D is a finite positive real number.

85. The network of claim 76, wherein to determine includes to randomly select the disc address set through random sampling from a collection of disc addresses stored at the web site.

86. The network of claim 76, wherein to determine includes to deterministically select the disc address set through a deterministic selection of disc addresses from a collection of disc addresses stored at the web site.

87. The method of claim 76, wherein if the web site has received the request from the WebDVD system for the web content within a predetermined time interval following a prior request received from the WebDVD system, then to determine includes to have the disc address set be a unique disc address set that has never been used and is intended not to be used again in the future for the WebDVD system.

88. The network of claim 76, wherein the disc address set directly points to the data block.

89. The network of claim 76, wherein the disc address set indirectly points to the data block.

90. The network of claim 76, wherein a disc address of the disc address set is a function of the date and time at which the request is received by the web site from the WebDVD system.

91. The network of claim 76, wherein the web site is further adapted to transmit to the WebDVD system the extent of the data block, and wherein the data block is determined by the disc address set and the extent.

92. The network of claim 76, wherein the web site is further adapted to cause the disc address set to be placed in a cookie that may be stored in the WebDVD system.

93. The network of claim 76, wherein the WebDVD system comprises a WebDVD player that includes the DVD device.

94. The network of claim 93, wherein the WebDVD player includes a display device for displaying data relating to the DVD disc.

95. The network of claim 94, wherein the display device is external to the WebDVD player.

96. The network of claim 76, wherein the WebDVD system comprises a computer system that couples the DVD device to the communication link, and wherein the DVD device is external to the computer system.

97. The network of claim 76, wherein the WebDVD system comprises a computer system that couples the DVD device to the communication link, and wherein the DVD device is within the computer system.

98. The network of claim 76, wherein the WebDVD system further includes an electronics device that is adapted to operate in conjunction with the DVD device.

99. The network of claim 76, wherein the web site is further adapted to automatically generate:
another disc address set that points to a corresponding data set on the DVD disc for subsequent transmission of the another disc address set to some WebDVD system that subsequent requests said web content; and
a re-encryption of said web content in correspondence with said another disc address set.

100. The network of claim 76, wherein the communication link comprises the Internet.

101. A computer program product, comprising a computer usable medium having a computer readable program code embodied therein for decrypting web content associated with a DVD disc, said computer code embedded within a readable storage device of a WebDVD system, said computer code comprising an algorithm adapted to:
request, from a web site targeted by the DVD disc, web content associated with the DVD disc, wherein the DVD disc is running on a DVD device comprised by the WebDVD system, wherein the DVD device is linked by a communication link to the web site, and wherein the WebDVD system may have access to the web content only when the DVD disc is running on the DVD device;
receive from the web site a disc address set that points to a data block of the DVD disc;
acquire knowledge of the extent of the data block, wherein the data block is determined by the disc address set and the extent;
attempt to read the data block, and if a new disc address set requesting feature is operative on the WebDVD system and if said attempt to read the data block is not successful then: direct the web site to send a new disc address set to replace the previously received disc address set to point to a new data block on the DVD disc, and repeat a maximum of N times said receive, acquire, and attempt until said attempt is successful, wherein N is at least 1; and
map the data block to a decryption key by a defined function if said attempt is successful, wherein the decryption key may be used by the algorithm to decrypt the web content.

102. The computer program product of claim 101, wherein the algorithm is further adapted to:
receive the web content from the web site; and
decrypt the web content through use of the decryption key.

103. The computer program product of claim 101, wherein the algorithm is adapted to receive the disc address set such that upon receipt of the disc address set by the web site the data block is not encrypted.

104. The computer program product of claim 101, wherein the algorithm is adapted to receive the disc address set such that upon receipt of the disc address set by the web site the data block is encrypted, and wherein to map comprises to map the encrypted data block to the decryption key by the defined function.

105. The computer program product of claim 101, wherein the algorithm is adapted to receive the disc address set such that upon receipt of the disc address set by the web site the data block is encrypted, and wherein to map comprises:
to decrypt the data block to generate a decrypted data block; and
to map the decrypted data block to the decryption key by the defined function.

106. The computer program product of claim 101, wherein to map comprises:
to map the data block to an encrypted key by the defined function; and
to decrypt the encrypted key to generate the decryption key.

107. The computer program product of claim 101, wherein the defined function is an identity function.

108. The computer program product of claim 101, wherein the defined function is not an identity function.

109. The computer program product of claim 101, wherein the defined function has a dependence on the date and time at which the data block is mapped.

110. The computer program product of claim 101, wherein the disc address set directly points to the data block.

111. The computer program product of claim 101, wherein the disc address set indirectly points to the data block.

112. The computer program product of claim 101, wherein the extent has a predetermined value that is stored at a physical location within the WebDVD system, and wherein to acquire knowledge comprises to access the extent from said physical location.

113. The computer program product of claim 101, wherein the extent has a predetermined value that is stored at a logical location within the WebDVD system, and wherein to acquire knowledge comprises to access the extent from said logical location.

114. The computer program product of claim 101, wherein to acquire knowledge comprises to receive the extent from the web site.

115. The computer program product of claim 101, wherein the extent is the length of the data block.

116. The computer program product of claim 101, wherein the extent is defined by a physical or logical boundary on the DVD disc.

117. The computer program product of claim 101, wherein the WebDVD system comprises a WebDVD player that includes the DVD device.

118. The computer program product of claim 117, wherein the WebDVD player includes a display device for displaying data relating to the DVD disc.

119. The computer program product of claim 118, wherein the display device is external to the WebDVD player.

120. The computer program product of claim 119, wherein the display device is a television.

121. The computer program product of claim 1, wherein the WebDVD system comprises a computer system that couples the DVD device to the communication link, and wherein the DVD device is external to the computer system.

122. The computer program product of claim 1, wherein the WebDVD system comprises a computer system that couples the DVD device to the communication link, and wherein the DVD device is within the computer system.

123. The computer program product of claim 1, wherein the WebDVD system further includes an electronics device that is adapted to operate in conjunction with the DVD device.

124. The computer program product of claim 123, wherein a consumer electronics device comprises the electronics device coupled to the DVD device.

125. The computer program product of claim 1, wherein the communication link comprises the Internet.

126. A computer program product, comprising a computer usable medium having a computer readable program code embodied therein for transmitting, by a web site to a WebDVD system, information that may be used by the WebDVD system to generate a decryption key, said computer code embedded within a readable storage device of the web site, said computer code comprising an algorithm adapted to:
receive a present request from the WebDVD system for web content associated with a DVD disc that is running on a DVD device comprised by the WebDVD system, wherein the DVD device is linked by a communication link to the web site, wherein the web site is targeted by the DVD disc, and wherein the WebDVD system may have access to the web content only when the DVD disc is running on the DVD device;
determine a disc address set on the DVD disc, wherein the disc address set points to a data block on the DVD disc, wherein the data block is adapted to be mapped to a decryption key by a defined function, and wherein the decryption key is adapted to be used by the WebDVD system to decrypt the web content; and
send the disc address set to the WebDVD system.

127. The computer program product of claim 126, wherein to determine includes to determine the same disc address set sent by the web site to the DVD system at a previous time when the DVD system requested the web content.

128. The computer program product of claim 127, wherein to determine includes to randomly select the previous time from more than one previous times when the DVD system requested the web content.

129. The computer program product of claim 127, wherein to determine includes to deterministically randomly select the previous time from more than one previous times when the DVD system requested the web content.

130. The computer program product of claim 126, wherein to determine includes to determine the same disc address set sent by the web site to the DVD system at a last time when the DVD system requested the web content.

131. The computer program product of claim 126, wherein to determine includes to determine the same disc address set sent by the web site to the DVD system at a last time the DVD system requested the web content if the last time is not less than D days prior to the present request, and wherein D is a finite positive real number.

132. The computer program product of claim 126, wherein to determine includes to determine a different disc address set from a previous disc address set sent by the web site to the DVD system at a previous time the DVD system requested the web content.

133. The computer program product of claim 126, wherein to determine includes to determine a different disc address set from a last disc address set sent by the web site to the DVD system at a last time the DVD system requested the web content.

134. The computer program product of claim 126, wherein to determine includes to determine a different disc address set from a last disc address set sent by the web site to the DVD system at a last time the DVD system requested the web content if the last time is more than D days prior to
the present request, and wherein D is a finite positive real number.

135. The computer program product of claim 126, wherein to determine includes to randomly select the disc address set through random sampling from a collection of disc addresses stored at the web site.

136. The computer program product of claim 126, wherein to determine includes to deterministically select the disc address set through a deterministic selection of disc addresses from a collection of disc addresses stored at the web site.

137. The method of claim 126, wherein if the web site has received the request from the WebDVD system for the web content within a predetermined time interval following a prior request received from the WebDVD system, then to determine includes to have the disc address set be a unique disc address set that has never been used and is intended not to be used again in the future for the WebDVD system.

138. The computer program product of claim 126, wherein the disc address set directly points to the data block.

139. The computer program product of claim 126, wherein the disc address set indirectly points to the data block.

140. The computer program product of claim 126, wherein a disc address of the disc address set is a function of the date and time at which the request is received by the web site from the WebDVD system.

141. The computer program product of claim 126, wherein the algorithm is further adapted to transmit to the WebDVD system the extent of the data block, and wherein the data block is determined by the disc address set and the extent.

142. The computer program product of claim 126, wherein the algorithm is further adapted to cause the disc address set to be placed in a cookie that may be stored in the WebDVD system.

143. The computer program product of claim 126, wherein the WebDVD system comprises a WebDVD player that includes the DVD device.

144. The computer program product of claim 143, wherein the WebDVD player includes a display device for displaying data relating to the DVD disc.

145. The computer program product of claim 144, wherein the display device is external to the WebDVD player.

146. The computer program product of claim 126, wherein the WebDVD system comprises a computer system that couples the DVD device to the communication link, and wherein the DVD device is external to the computer system.

147. The computer program product of claim 126, wherein the WebDVD system comprises a computer system that couples the DVD device to the communication link, and wherein the DVD device is within the computer system.

148. The computer program product of claim 126, wherein the WebDVD system further includes an electronics device that is adapted to operate in conjunction with the DVD device.

149. The computer program product of claim 126, wherein the algorithm is adapted to automatically generate:
another disc address set that points to a corresponding data set on the DVD disc for subsequent transmission of the another disc address set to some WebDVD system that subsequent requests said web content; and
a re-encryption of said web content in correspondence with said another disc address set.

150. The computer program product of claim 126, wherein the communication link comprises the Internet.
